(19) United States
(12) Patent Application Publication
(10) Pub. No.: US 2008/0201509 A1
(43) Pub. Date: Aug. 21, 2008

(54) Component, device and operation method for digital data integration

(76) Inventor: Chin-Wen Cheng, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/068,366

(22) Filed: Feb. 6, 2008

(30) Foreign Application Priority Data
Feb. 9, 2007 (TW) 96104810

(51) Int. Cl. G06F 13/14

(52) U.S. Cl. 710/106

(57) ABSTRACT

A component, device and operation method for digital data integration solves the shortcoming of the prior art that playing audio recordings and reading/writing AV data cannot be performed simultaneously. The digital data integration device receives a start signal from a computer to enable a plurality of endpoints declared in a program memory unit of the digital data integration component. The present invention utilizes a bulk mode for audio input/output endpoint to play/record audio data and a bulk mode for mass-storage read/write endpoint to upload/download digital data through a control endpoint combination with an interrupt read endpoint and an interrupt write endpoint. The present invention can play/record sound data and upload/download digital data simultaneously.

### BACKGROUND OF THE INVENTION

1. Field of the Invention

The present invention relates to a component, device and operation method for digital data integration. Specifically, the present invention provides playing sound data and reading/writing audiovisual (AV) data simultaneously in a digital data integration device.

2. Description of Related Art

Currently, digital AV play devices with USB function can be connecting to a computer via a USB cable to upload/download data, store data and play/record music or other sounds. However, the present abilities of digital AV play devices only provides a single function of uploading/downloading data and storing data or playing music or other sounds. The digital AV play devices cannot achieve playing sound data and reading/writing AV data simultaneously.

Digital AV play devices of the current art can access digital AV data stored on memory for playing sounds, displaying images or converting sound via a microphone into digital data stored in memory. Digital AV play devices can be accessed like a computer storage disk when connected to a computer via USB cable, and the computer can thus access AV data stored on the digital AV play device. However, screen function, audio input/output function, and operating button of the digital AV play device cannot be used normally while the digital AV play device connects to a computer.

### SUMMARY OF THE INVENTION

It is an object of the present invention to provide a component, device and operation method for digital data integration to enable a user to play sound data and read/write AV data in/from the digital data integration device simultaneously.

The present invention of a digital data integration component comprises a control unit; a program memory unit stored as firmware code connected to the control unit via an internal bus; a data memory unit connected to the control unit via the internal bus for using as a memory space by executing the firmware code; a USB controller unit connected to the control unit for transmitting/receiving a USB controller command; an audio converter unit transmitting/receiving at least one set of sound data and executing data transformation through the control unit via the internal bus; and a memory controller unit connected to the control unit via the internal bus for accessing at least one set of digital data controlled by the control unit.

The present invention of a digital data integration device having read/write AV data and play sound data function connects to a computer, comprises a digital data integration component; a second USB controller unit inside the computer connected to the first USB controller unit for receiving a USB control command from the first USB controller unit; an audio input/output connected to the audio converter unit for inputting/outputting the sound data; and a memory storage unit connected to the memory controller unit for storing the digital data.

The digital data integration component comprises a control unit; a program memory unit containing firmware code, and connected to the control unit via an internal bus; a data memory unit connected to the control unit via the internal bus used as a memory space for executing the firmware code; a first USB controller unit connected to the control unit for transmitting/receiving a USB controller command; an audio converter unit transmitting/receiving at least one set of sound data and executing data transformation through the control unit via the internal bus; a memory controller unit connected to the control unit via the internal bus for accessing at least one set of digital data controlled by the control unit.

An operation method for a digital data integration device having read/write AV data and play sound data functions, which can be connected to a computer, comprising: detecting whether the digital data integration device is connected to the computer or not; transmitting a command query signal from the computer to the digital data integration device; enabling a plurality of endpoints in accordance with the command query signal and reporting the endpoint's status to the computer; determining a command control instruction from the computer; and driving the command control instruction in response to one of the endpoints to execute the digital data integration device operation.

The digital data integration device receives a start signal from the computer to enable a plurality of endpoints declared on the firmware code inside of the program memory of digital data integration component. A control unit of the digital data integration component combines a control endpoint and a time-sharing ability to achieve playing sound data and reading/writing AV data in the digital data integration device simultaneously.

The various objects and advantages of the present invention will be more readily understood from the following detailed description when read in conjunction with the appended drawing, in which:

### BRIEF DESCRIPTION OF DRAWING

FIG. 1 shows a block diagram of digital data integration component according to the present invention;

FIG. 2 shows a block diagram of digital data integration device according to the present invention;

FIG. 3 shows a flowchart of the present invention of the digital data integration device.

### DETAILED DESCRIPTION OF THE INVENTION

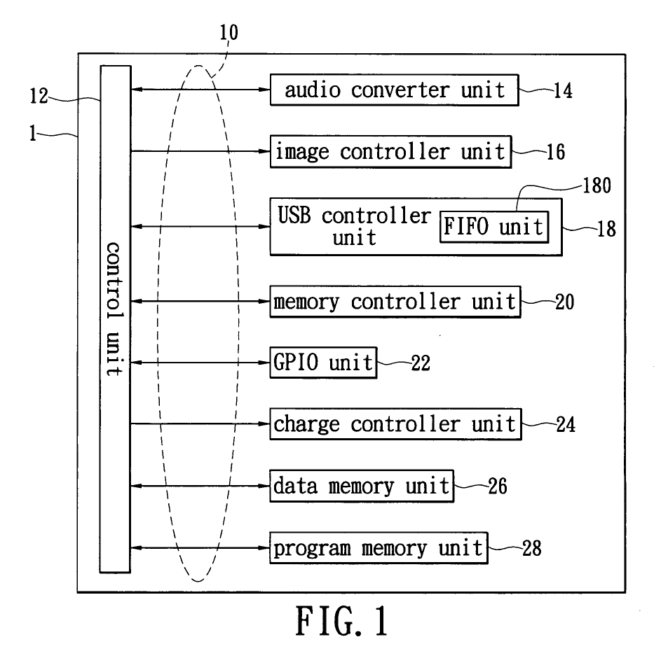

FIG. 1 shows a block diagram of digital data integration components according to the present invention, which comprise an internal bus 10, a control unit 12, an audio converter unit 14, an image controller unit 16, a USB controller unit 18, a memory controller unit 20, a general purpose input/output (GPIO) unit 22, a charge controller unit 24, a data memory unit 26 and a program memory unit 28, wherein the USB controller unit 18 further comprises a First In, First Out (FIFO) unit 180.

The program memory unit connects to the internal bus 10 and stores a firmware code. The firmware code declares a plurality of endpoints. The preferred embodiment has 7 endpoints declaration, but the present invention is not limited to this number. The maximum number of endpoints is dependent on the support ability of the physical layer of USB controller unit 18. The 7 endpoints may consist of a controller endpoint, an audio input endpoint, an audio output endpoint, a bulk mode for mass-storage read endpoint, a bulk mode for mass-storage write endpoint, an interrupt read endpoint and an interrupt write endpoint.

The control unit 12 executes the firmware code of the program memory unit 28 to enable the 7 endpoints via the internal bus 10. The control unit 12 drives the audio converter unit 14 and the memory controller unit 20 through the 7 endpoints declaration mode. In operation, the operation time of the control unit 12 and the computer is the same. The FIFO 180 inside of the USB control unit 18 executes at least one command generated by the 7 endpoints in accordance with a scheduled process.

The audio converter unit 14 further comprises an analog/digital audio converter and a digital/analog audio converter for converting analog sound data into digital data. The image controller unit 16 connects to the control unit 12 via the internal bus 10 for obtaining image data included in the digital data and transmitting the image data to an image display unit. The memory controller unit 20 connects to the control unit 12 via the internal bus 10 for accessing at least one set of digital data, and is controlled by the control unit 12. The GPIO unit 22 executes input/output in accordance with an input/output control signal provided by the control unit 12. The charge controller unit 24 connects to the control unit 12 via the internal bus 10 for receiving a charge control signal provided by the control unit 12 in order to charge an external battery by means of a battery charging unit. The data memory unit 26 connects to the control unit 12 via the internal bus 10 to serve as a memory space when the firmware code is executed.

The control unit 12 may be a micro control unit or a single chip processor. The audio converter unit 14 may be a digital/analog converter chip and an analog/digital converter chip. The image controller unit 16 may be an image controller chip. The memory controller unit 20 may be a flash memory. The data memory unit 26 and the program memory unit 28 may be an internal random access memory. The data memory unit 26 and the program memory unit 28 can utilize the same random access memory. The digital data integration component 1 can be integrated on a system-on-a-chip (SOC).

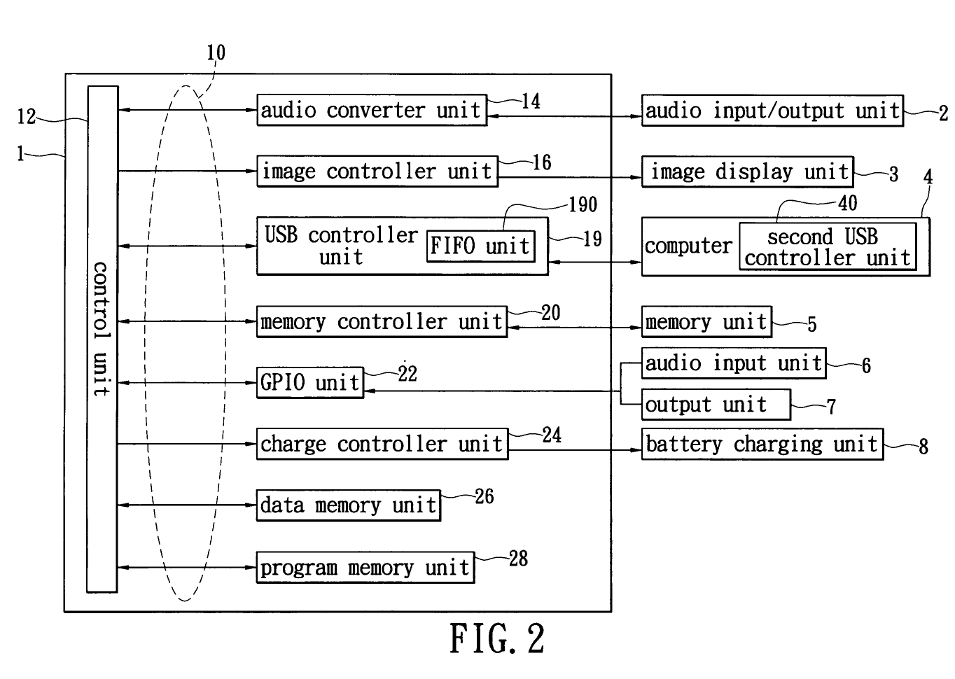

FIG. 2 shows the block diagram of digital data integration device according to the present invention, the digital data integration device connects to a computer 4. The digital data integration device has read/write AV data and play audio data function. The digital data integration device comprises a digital data integration component 1, an audio input/output unit 2, an image display unit 3, a second USB controller unit 40, a memory unit 5, an audio input unit 6, an output unit 7 and a battery charging unit 8. The computer 4 includes a motherboard, a hard disk, a memory and central processor unit.

The digital data integration component 1 comprises an internal bus 10, a control unit 12, an audio converter unit 14, an image controller unit 16, a USB controller unit 18, a memory controller unit 20, a GPIO unit 22, a charge controller unit 24, a data memory unit 26 and a program memory unit 28, wherein the USB controller unit 18 further comprises FIFO unit 180.

The operation of the digital data integration component 1 is shown in the FIG. 1 and described above. FIG. 2 uses the same nomenclature as FIG. 1.

The memory unit 5 may be a flash memory or a memory card. The memory card may be a SD card, a CF card or a MMC card. The audio input/output unit 2 includes an audio input device and an audio output device. The audio input device may be a microphone. The audio input device inputs at least one analog audio signal from a user or from an external device to the digital data integration component. The control unit 12 executes the firmware code stored on the program memory unit 28 for enabling audio output endpoint inside of the firmware code. The control unit 12 encodes the digital audio signal to music format data via the firmware code. The control unit 12 transmits the encoded data to the memory control unit 20 and stores it in the memory unit 5.

The audio input device may be an ear phone or a speaker. The control unit 12 executes the firmware code stored on the program memory unit 28 for enabling the audio input endpoint inside of the firmware code when the user wants to play the audio data stored on the memory unit 5. The control unit 12 decodes the audio data stored on the memory unit through the firmware code and transmits the decoded audio data to the audio converter unit 14 via the internal bus 10. The audio converter unit 14 converts the digital sound to analog audio signals and transmits the analog audio signal to be played through the audio output device of the audio input/output unit 2.

The input device 6 and output device 7 connects to the GPIO unit 22. The input device 7 may be a keyboard, a mouse or a keypad. The output device may be an LED panel, an LCD panel, an OLED panel, a backlight or an extended memory unit. The second USB controller unit 40 transmits an enable signal to the first USB controller unit 19 when the first USB controller unit 19 of the digital data integration component 1 is inserted in the second USB controller unit 40 of the computer 4. The control unit 12 enables the 7 endpoints stored in the program memory unit 28 via the firmware code. The 7 endpoints are a control endpoint, an audio input endpoint, an audio output endpoint, a bulk mode for mass-storage read endpoint, a bulk mode for mass-storage write endpoint, an interrupt read endpoint and an interrupt write endpoint.

The second USB controller unit 40 transmits the enable signal to the first USB controller unit 19 for driving control unit 12 to enable the 7 endpoints via the firmware code when the user wants to transmit the digital data of the computer 4 to the memory unit 5. The control unit 12 utilizes the bulk mode for mass-storage write endpoint for transmitting the digital data of the computer from the second USB control unit 40 to the first USB control unit 19. The digital data is transmitted to the memory unit 5 for storage via the internal bus 10 of digital data integration component 1.

The control unit 12 utilizes the bulk mode for mass-storage read endpoint for reading the digital data stored on the memory unit 5 via the memory controller unit 20 when the user wants to read the digital data stored in the memory unit 5. The first USB controller unit 19 transmits the digital data read from the memory unit 5 via the internal bus 10 to the second USB controller unit 40 and displays the digital data on the computer 4.

The control unit 12 controls the reading/writing of sound data and digital data via the control endpoint. The control unit 12 utilizes the time-sharing ability of the firmware code to drive the interrupt read endpoint and the interrupt write endpoint for reading or writing of the sound data and the digital data individually.

The status of the digital data integration device transmits digital data to the image display unit 3 for display by means of the image controller unit 16. The image display unit 3 may be an LCD monitor. The digital data integration device can be a portable digital data integration device. The digital data integration device accesses the digital data stored in the memory unit 5 for playing audio. The image or sound inputted from the microphone is converted into digital data to be stored in the memory unit 5.

The firmware code inside the digital integration device is started, and the digital data integration device acts as an audio device, a disk device or a human-machine interface device for computer 4 when the digital data integration device is combined with computer 4. If the digital integration device acts as an audio device, the computer 4 converts digital sound data transmitted from a USB protocol into analog audio signals to be played via the audio converter unit 14, or the digital data integration device converts analog audio signals to digital sound data via the audio converter unit 14 and transmits the digital sound data to the control unit 12. The control unit 12 transmits the digital sound data to the computer 4 through the USB protocol. If the digital data integration device acts as a disk device, the firmware code declares the digital data integration device as a CD-ROM drive, a removable disk or a non-removable disk. If the digital data integration device is used as a human-machine interface device, the firmware code will drive the buttons, LEDs or other input/output controls.

If the digital data integration device is declared as a CD-ROM and the computer 4 supports an auto-run function, the computer 4 executes a predetermine application program from a CD-ROM image file via USB protocol whereby the digital data integration device stores the CD-ROM image file. If the computer does not support an auto-run function, the computer 4 executes the application program stored in the memory unit 5 via USB protocol directly. If the digital data integration device is declared as a removable disk or a non-removable disk, the computer 4 accesses the digital data stored in the memory unit 5 via USB protocol.

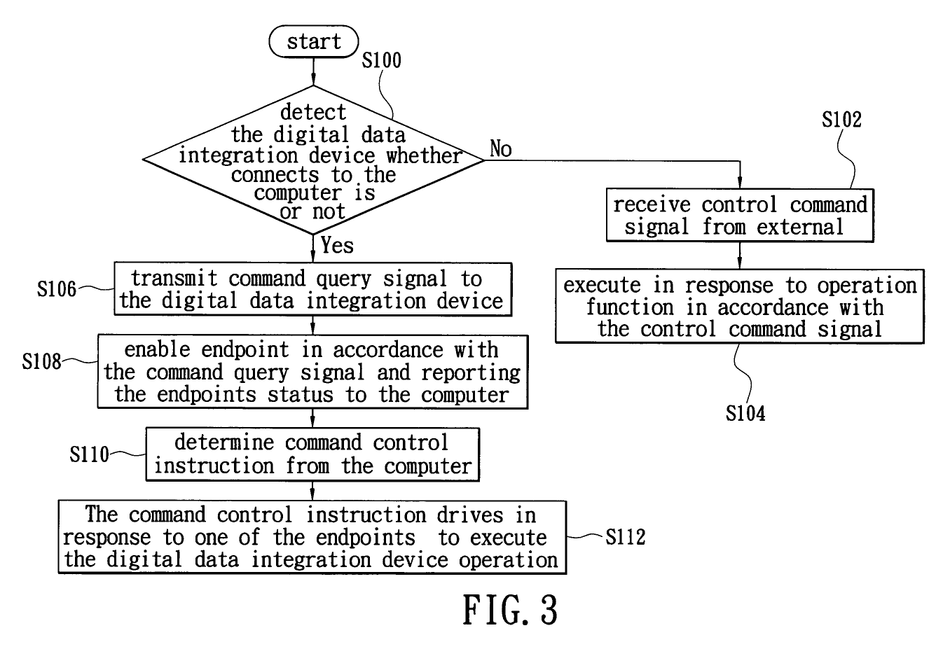

Referring to FIG. 2 and FIG. 3, FIG. 3 shows an operation method of the digital data integration device according to the present invention. The digital data integration device connects to a computer 4 and the digital data integration device have read/write AV data and play sound data function. The digital data integration device is started through a power switch or USB port providing power from the computer 4. The firmware code detects whether the digital data integration device is connected to the computer 4 or not (S100). The firmware code also detects whether the computer 4 receives a connection signal. If the detection result is no, the digital data integration device does not connect to the computer 4. Thus, the digital data integration device acts as a stand alone device. The digital data integration device receives a control command signal from an external source (S102). The control command signal may be a user interface control command, a play AV control command or a power-mode control command. The digital data integration device executes a plurality of operation functions in accordance with the control command signal (S104).

If the control command signal is a user interface control command, the digital data integration device provides a user operation interface. The user only needs to press the operation interface (such as buttons) on the digital data integration device for activating functions such as volume, stop or play. The functions retrieve file structure, file name and information from memory unit 5.

If the control command signal is the play AV control command, the AV data stored in the memory unit 5 is accessed for playing. The digital data integration device operates various kinds of function via the operation interface, such as start, stop, forward or reverse. If the control command signal is a power-mode control command, the firmware code detects which kind of power-mode is present in the digital data integration device. If detecting that the first USB controller unit 19 provides power to the digital data integration device, the digital data integration device is changed from stand alone mode to device operation mode. If the power button on the operation interface of digital data integration device is off, the digital data integration device enters a power-saving mode until the first USB controller unit 19 provides voltage or the power button is switch on.

In step S100, if detecting that the digital data integration device is connected to computer 4, the computer 4 transmits a command query signal to the digital data integration device (S106), enabling a plurality of endpoints in accordance with the command query signal and reporting the endpoint status to computer (S108). The 7 endpoints are a control endpoint, an audio input endpoint, an audio output endpoint, a bulk mode for mass-storage read endpoint, a bulk mode for mass-storage write endpoint, an interrupt read endpoint and an interrupt write endpoint.

The firmware code starts USB interrupt service to initialize the digital data integration device. The firmware code obtains data to analyze from the FIFO 190 of the first USB control unit 19 when the USB interrupt services detect a command control instruction from the computer 4 (S110). The command control instruction drives one of the endpoints to operate the digital data integration device (S112).

The audio input endpoint and audio output endpoint are channels for the digital data. The firmware code sets an interrupt request in accordance with the audio sampling frequency. When the interrupt request is issued, the firmware code stores the digital data in the data memory unit 26 for buffering, wherein the digital data is changed from analog to digital data by the analog/digital converter of the audio converter unit 14. The digital data returns to the computer 4 via the audio input endpoint, and the computer transmits the digital audio data via the audio output endpoint when the computer 4 detects digital audio data. The firmware code stores the digital audio data in the data memory unit 26 and transmits the analog audio data to the audio output device in accordance with the interrupt request. The analog audio data is generated from digital audio data of audio by the digital/analog converter of the audio converter unit 14. The bulk mode for mass-storage read endpoint and the bulk mode for mass-storage write endpoint are a set as a pipe for bulk mode for mass-storage. The bulk mode for mass-storage read endpoint, the bulk mode for mass-storage write endpoint and the control endpoint use the memory unit 5. The bulk mode for mass-storage read endpoint and the bulk mode for mass-storage write endpoint is packaged a Small Computer System Interface (SCSI) command of the USB protocol for operating read sector, write sector and read data title. The bulk mode for mass-storage write endpoint is a write data instruction from the computer 4 to the memory unit 5. The bulk mode for mass-storage read endpoint is read data instruction from the memory unit 5 to the computer 4. The computer 4 utilizes the Small Computer System Interface (SCSI) command for obtaining disk description, such as a declaration of a CD-ROM, a removable or non-removable disk.

The interrupt read endpoint and the interrupt write endpoints are used as an external operation interface of the application program, such as a button message, an LED operation or input/output operation.

The present invention has below advantages:
1. The present invention declares 7 endpoints to read/write data to/from the digital data integration device using a computer and listen to audio data using the digital data integration device simultaneously. The present invention utilizes the control unit for controlling the data access or read audio data in accordance with a control endpoint. The digital data integration component of the present invention could be integrated in a single chip.
2. Compared to the prior art, the present invention can integrate the memory unit and the digital data integration component in the portable digital data integration device for achieving this objective.

Although the present invention has been described with reference to the preferred embodiment therefore, it will be understood that the invention is not limited to the details thereof. Various substitutions and modification s have suggested in the foregoing description, and other will occur to those of ordinary skill in the art. Therefore, all such substitutions and modifications are intended to be embrace within the scope of the invention as defined in the appended claims.

What is claimed is:

1. A digital data integration component, comprising:
a control unit;
a program memory unit storing a firmware code, connected to the control unit via an internal bus;
a data memory unit connected to the control unit via the internal bus used as a memory space for executing the firmware code;
a USB controller unit connected to the control unit for transmitting/receiving a USB controller command;
an audio converter unit for transmitting/receiving at least one set of sound data and executing data transformation through the control unit via the internal bus; and
a memory controller unit controlled by the control unit and connected to the control unit via the internal bus for accessing at least one set of digital data.

2. The component as in claim 1, further comprising:
an image controller unit connected to the control unit via the internal bus for obtaining image data included in the digital data and transmitting the image data to an image display unit;
a GPIO unit connected to the control unit via the internal bus executing input/output provided by the control unit; and
a charge controller unit connected to the control unit via the internal bus providing a charge controller signal from the control unit to a charge unit for charging an external battery.

3. The component as in claim 1, wherein the firmware code declares a plurality of end-points.

4. The component as in claim 1, wherein the USB controller unit further comprises a FIFO unit for executing scheduled commands generated by the end-points.

5. The component as in claim 1, wherein the audio converter unit comprises an analog/digital audio converter and a digital/analog audio converter for converting audio data from analog to digital and vice versa.

6. The component as in claim 1, wherein the digital data integration component is integrated in a System-on-chip (SOC).

7. A digital data integration device having read/write AV data and play audio data functions connected to a computer, comprising:
a digital data integration component, comprising:
a control unit;
a program memory unit stored a firmware code connected to the control unit via an internal bus;
a data memory unit connected to the control unit via the internal bus used as a memory space for executing the firmware code;
a first USB controller unit connected to the control unit for transmitting/receiving a USB controller command;
an audio converter unit transmitting/receiving at least one set of sound data and executing data transformation through the control unit via the internal bus;
a memory controller unit controlled by the control unit and connected to the control unit via the internal bus for accessing at least one set of digital data;
a second USB controller unit connected to the computer and connected to the first USB controller unit for receiving a USB control command from the first USB controller unit;
an audio input/output device connected to the audio converter unit for inputting/outputting the sound data; and
a memory unit connected to the memory controller unit for storing the digital data.

8. The device as in claim 7, wherein the digital data integration component further comprises:
an image controller unit connected to the controller via the internal bus for obtaining the image data included in the digital data, transmitting the image data to an image display unit of the external;
a GPIO unit connected to the control unit via the internal bus for executing input/output provided by an input/output control signal in accordance with the control unit;
a charging controller unit connected to the control unit via the internal bus for providing a charging control signal to a battery charging unit for charging an external battery; and
an input unit and an output unit connected to the GPIO unit for receiving or transmitting at least one command instruction and the digital data.

9. The device as in claim 7, wherein the firmware code declares a plurality of endpoints.

10. The device as in claim 7, wherein the first USB controller unit further comprises a FIFO unit for executing commands generated by the endpoints via a schedule process.

11. The device as in claim 7, wherein the audio converter unit further comprises an analog/digital audio converter and a digital/analog converter for converting analog audio data to digital and digital audio data to analog.

12. The device as in claim 7, wherein the memory unit is a flash memory or a memory card.

13. The device as in claim 7, wherein the digital data integration component is integrated in an SOC.

14. The device as in claim 8, wherein the image display unit is an LCD monitor.

15. The device as in claim 8, wherein the input unit is a keyboard, a mouse or a keypad.

16. The device as in claim 8, wherein the output unit is an LED panel, an LCD panel, an OLED panel, a backlight or an extended memory unit.

17. An operation method for a digital data integration device having read/write AV data and play sound data functions connected to a computer, comprising:
detecting whether the digital data integration device is connected to the computer or not;
transmitting a command query signal from the computer to the digital data integration device;
enabling a plurality of endpoints in accordance with the command query signal and reporting the endpoint status to the computer;
determining a command control instruction from the computer; and
driving the command control instruction in response to one of the endpoints to operate the digital data integration device.

18. The operation method as in claim 17, wherein in the step of detecting the digital data integration device a command query signal is transmitted from the computer to the digital data integration device if the detection result is true, and the following steps are executed if the detection result is false:
receiving a control command signal from the external; and
executing the digital data integration operation function in accordance with the control command signal.

19. The operation method as in claim 17, wherein the endpoints are a control terminal, an audio input endpoint, a bulk mode for mass-storage read endpoint, a bulk mode for mass-storage write endpoint, a interrupt read endpoint and a interrupt write endpoint.

20. The operation method as in claim 18, wherein the control command signal is a user interface control command, a play AV control command or a power mode control command.
